(19) United States
(12) Patent Application Publication
(10) Pub. No.: US 2014/0270210 A1
(43) Pub. Date: Sep. 18, 2014

(54) System and Method for Hearing Prosthesis Fitting

(71) Applicant: Bastiaan van Dijk, Antwerp (BE)

(72) Inventor: Bastiaan van Dijk, Antwerp (BE)

(21) Appl. No.: 13/827,574

(22) Filed: Mar. 14, 2013

(51) Int. Cl. H04R 25/00

(52) U.S. Cl. CPC H04R 25/70
USPC 381/60

(57) ABSTRACT

A hearing prosthesis fitting system includes a first interface configured for applying a stimulation signal to a recipient of the hearing prosthesis. Generally, the stimulation signal is associated with a prior probability that the recipient will perceive the stimulation signal as an audible sound. The fitting system also includes a second interface configured for receiving response data relating to whether the recipient perceived the stimulation signal as an audible sound. Further, the fitting system includes a processor configured to determine an updated probability that the recipient perceived the stimulation signal as an audible sound. More particularly, the processor is configured to utilize the received response data and the prior probability to determine the updated probability.

### BACKGROUND

Various types of hearing prostheses provide persons with different types of hearing loss with the ability to perceive sound. Hearing loss may be conductive, sensorineural, or some combination of both conductive and sensorineural. Conductive hearing loss typically results from a dysfunction in any of the mechanisms that ordinarily conduct sound waves through the outer ear, the eardrum, or the bones of the middle ear. Sensorineural hearing loss typically results from a dysfunction in the inner ear, including the cochlea where sound vibrations are converted into neural signals, or any other part of the ear, auditory nerve, or brain that may process the neural signals.

Persons with some forms of conductive hearing loss may benefit from hearing prostheses, such as acoustic hearing aids or vibration-based hearing devices. An acoustic hearing aid typically includes a small microphone to detect sound, an amplifier to amplify certain portions of the detected sound, and a small speaker to transmit the amplified sounds into the person's ear. Vibration-based hearing devices typically include a small microphone to detect sound and a vibration mechanism to apply vibrations corresponding to the detected sound directly or indirectly to a person's bone or teeth, for example, thereby causing vibrations in the person's inner ear and bypassing the person's auditory canal and middle ear. Vibration-based hearing devices include, for example, bone anchored devices, direct acoustic cochlear stimulation devices, or other vibration-based devices. A bone-anchored device typically utilizes a surgically implanted mechanism or a passive connection through the skin or teeth to transmit vibrations corresponding to sound via the skull. A direct acoustic cochlear stimulation device also typically utilizes a surgically implanted mechanism to transmit vibrations corresponding to sound, but bypasses the skull and more directly stimulates the inner ear. Other non-surgical vibration-based hearing devices may use similar vibration mechanisms to transmit sound via direct or indirect vibration of teeth or other cranial or facial bones or structures.

Persons with certain forms of sensorineural hearing loss may benefit from hearing prostheses, such as cochlear implants and/or auditory brainstem implants. For example, cochlear implants can provide a person having sensorineural hearing loss with the ability to perceive sound by stimulating the person's auditory nerve via an array of electrodes implanted in the person's cochlea. A component of the cochlear implant detects sound waves, which are converted into a series of electrical stimulation signals that are delivered to the implant recipient's cochlea via the array of electrodes. Auditory brainstem implants can use technology similar to cochlear implants, but instead of applying electrical stimulation to a person's cochlea, auditory brainstem implants apply electrical stimulation directly to a person's brainstem, bypassing the cochlea altogether. Electrically stimulating auditory nerves in a cochlea with a cochlear implant or electrically stimulating a brainstem may enable persons with sensorineural hearing loss to perceive sound.

Further, some persons may benefit from hearing prostheses that combine one or more characteristics of acoustic hearing aids, vibration-based hearing devices, cochlear implants, and auditory brainstem implants to enable the person to perceive sound. Such hearing prostheses can be referred to generally as hybrid hearing prostheses.

The effectiveness of a hearing prosthesis depends not only on the design of the prosthesis itself but also on how well the prosthesis is configured for or fitted to a prosthesis recipient. The fitting of the prosthesis, sometimes also referred to as programming or mapping, creates a set of configuration settings and other data that defines the specific characteristics of the signals (acoustic, mechanical, or electrical) delivered to the relevant portions of the recipient's outer ear, middle ear, inner ear, or auditory nerve. This configuration information is sometimes referred to as the recipient's program, map, or prescription rule.

Generally, fitting a hearing prosthesis involves an audiologist or other similarly trained professional or clinician who may use a prosthesis fitting system to apply stimulation signals for different channels and channel levels of the prosthesis. The clinician then interprets a behavioral indication, such as verbal feedback, from the recipient that relates to the recipient's perception of the stimulation signals as sound. For prostheses with a large number of stimulation channels the fitting process can be quite time consuming and generally relies on the recipient's subjective impression of the stimulation. Also, this psychophysics approach is further limited in cases of children, infants, and prelingually or congenitally deaf recipients who are limited in their abilities to provide an accurate verbal impression of a hearing sensation.

### SUMMARY

Aspects of the present disclosure relate generally to fitting an auditory prosthesis to a recipient and, more particularly, to adjusting or updating probabilities that the recipient perceived a stimulation signal as sound based on observed events. In one aspect or embodiment, a fitting system receives inputs from the clinician and/or other detectors regarding determinations that the recipient has perceived a stimulation signal as sound. In this aspect, the fitting system utilizes these inputs to update probabilities that the recipient did perceive the stimulation signal as sound. In another aspect, the clinician or other detectors are not made aware of the application of the stimulation signals and/or of the parameters of an applied stimulation signal, e.g., a level and/or channel of the stimulation signal. In this example, the fitting system can select the parameters of the stimulation signals and/or can selectively apply the stimulation signals without informing the clinician or other detectors.

The fitting system may also track false positive rates, which occur when a stimulation signal is not perceived as sound, yet a detector determines that a stimulation signal was perceived as sound. Likewise, the fitting system may track false negative rates, which occur when a stimulation signal was perceived as sound, but a detector did not recognize that the recipient perceived the stimulation signal. These false positive and false negative rates can also be used to update the probabilities that the recipient perceived a stimulation signal as sound. Another further aspect includes using multiple detectors, such as multiple clinicians, parents, physiological sensors, etc., to update the likelihood or probability that the recipient perceived a stimulation signal as sound.

The above and additional aspects, examples, and embodiments are further described in the present disclosure.

### BRIEF DESCRIPTION OF THE DRAWINGS

FIG. 1 illustrates a hearing prosthesis, in this case, a cochlear implant, which is coupled to a recipient, in accordance with one example of the present disclosure.

FIG. 2 shows a diagrammatic view of an example fitting arrangement for a hearing prosthesis, in accordance with one example of the present disclosure.

FIG. 3 is a block diagram of a computing device that may be configured as a fitting system for use in the fitting arrangement of FIG. 2, in accordance with one example of the present disclosure.

FIG. 4 is a flowchart showing an example method or algorithm for applying stimulation signals to a hearing prosthesis recipient and updating probabilities for use in a fitting process.

FIG. 5 is a flowchart showing another example method or algorithm for applying stimulations signals to a hearing prosthesis recipient and updating data for use in a fitting process.

### DETAILED DESCRIPTION

The following detailed description describes various features, functions, and attributes with reference to the accompanying figures. In the figures, similar symbols typically identify similar components, unless context dictates otherwise. The illustrative embodiments described herein are not meant to be limiting. Certain features, functions, and attributes disclosed herein can be arranged and combined in a variety of different configurations, all of which are contemplated in the present disclosure.

Various embodiments of the present disclosure may be implemented in conjunction with a variety of auditory prostheses commercially available today or developed in the future. Further, many features and functions disclosed herein may be equally applicable to other types of devices, including other types of medical and non-medical devices. However, for ease of illustration, embodiments are described herein in conjunction with the fitting of one particular type of medical device, a cochlear implant.

In this context, although the present disclosure may be implemented to facilitate the fitting of a hearing prosthesis to any type of patient, the present disclosure provides particular benefits when fitting a hearing prosthesis to children, infants, and prelingually or congenitally deaf recipients who are unable to provide an audiologist with an accurate impression of the hearing sensation resulting from an applied stimulation signal. Accordingly, embodiments are described herein in conjunction with the fitting of a cochlear implant to one particular recipient, a child.

Referring now to FIG. 1, a cochlear implant 50 in accordance with an embodiment of the present disclosure is illustrated with components coupled to an individual's hearing system, which generally includes an outer ear 52, a middle ear 54, and an inner ear 56. In a fully functional ear, the outer ear 52 comprises an auricle 58 and an ear canal 60. An acoustic pressure or sound wave 62 is collected by the auricle 58 and channeled into and through the ear canal 60. A tympanic membrane 64 is disposed across a distal end of the ear canal 60. The tympanic membrane 64 vibrates in response to the sound wave 62. This vibration is transferred to an oval window or fenestra ovalis 66 through three bones of the middle ear 54, collectively referred to as ossicles 68, and comprising a malleus 70, an incus 72, and a stapes 74. The bones 70-74 of the middle ear 54 serve to filter and amplify the sound wave 62 and cause the oval window 66 to articulate or vibrate in response to vibration of the tympanic membrane 64. The oval window 66 is further coupled to a cochlea 76, such that vibration of the oval window sets up waves of fluid motion within the cochlea. Such fluid motion, in turn, activates tiny hair cells (not shown) inside of the cochlea 76. Activation of the hair cells causes appropriate nerve impulses to be generated and transferred through spiral ganglion cells (not shown) and an auditory nerve 78 to the brain (not shown) where they are perceived as sound.

Referring again to the cochlear implant 50, the illustrated hearing prosthesis includes an external component 100 that is directly or indirectly attached to the body of the recipient and an internal component 102 that is temporarily or permanently implanted in the recipient. In the example of FIG. 1, the external component 100 includes a sound processing unit 104 and an external transmitter unit 106. The sound processing unit 104 may include a digital signal processor (DSP), a power source, and a sound transducer 108. The sound transducer 108 is configured to detect sound and to generate an audio signal, typically an analog audio signal, representative of the detected sound. In one example, the sound transducer 108 includes a microphone. In other examples, the sound transducer 108 includes more than one microphone, one or more telecoil induction pickup coils, or other devices now or later developed that are configured to detect sound and generate electrical signals representative of the detected sound. In some embodiments, the sound transducer 108 may not be integrated into the sound processing unit 104 but rather can be a separate component of the external component 100.

In FIG. 1, the external transmitter unit 106 includes an external coil 110 of a transcutaneous energy transfer system along with associated circuitry to drive the coil. The external transmitter unit 106 may also include a magnet (not shown) secured directly or indirectly to the external coil 110. The magnet can be used to aid in the positioning of the external component 100 with respect to the internal component 102.

Generally, the sound processing unit 104 is configured to process the output of the sound transducer 108 that is positioned, as shown in FIG. 1, near the auricle 58 of the recipient. The sound processing unit 104 is configured to generate coded signals, which can be provided to the external transmitter unit 106 via a cable (not shown). The sound processing unit 104 shown in the present example is designed to fit generally behind the auricle 58. Alternative designs may be worn on the body or even incorporated into the internal component 102 to provide a fully implantable hearing prosthesis system.

The internal component 102 may include an internal receiver unit 112, a stimulator unit 114 and an electrode assembly 116. The internal receiver unit 112 and the stimulator unit 114 can be hermetically sealed within a biocompatible housing. In one example, the internal receiver unit 112 includes an internal coil, a magnet fixed relative to the internal coil, and associated circuitry (all not shown in FIG. 1). The internal coil can be a wire antenna coil comprised of multiple turns of electrically insulated single-strand or multi-strand wire, such as platinum or gold wire. In the example of FIG. 1, the internal receiver unit 108 is positioned in a recess of the temporal bone adjacent an auricle 58 of the recipient. Further, the external coil 108 can be held in place and aligned with the implanted internal coil via the above-noted magnets. The external coil transmits electrical signals, such as power and stimulation data, to the internal coil via a radio frequency (RF) link, for example.

In FIG. 1, the electrode assembly 116 extends from the stimulator unit 114 to the cochlea 76 and terminates in an array 118 of electrodes 120. Stimulation signals generated by the stimulator unit 114 are applied by the electrodes 120 to the cochlea 76, thereby stimulating the auditory nerve 78 of the hearing prosthesis recipient.

As shown in FIG. 1, the cochlear implant 50 is configured to interoperate with a hearing prosthesis fitting system 130. The fitting system 130 may be implemented with a computing device, such as a personal computer, workstation, handheld computing device, or the like.

FIG. 2 is a schematic diagram illustrating an example arrangement 150 where an audiologist or clinician 152 uses the fitting system 130 to fit a hearing prosthesis, such as the cochlear implant 50, to a recipient 154. Generally, the fitting system 130 includes interactive software and computer hardware and/or firmware configured to apply stimulation signals 156 to the recipient via the hearing prosthesis. Further, the fitting system 130 is configured to receive response data 158 relating to whether the recipient 154 perceived a stimulation signal 156 as sound. The response data 158 can be received from one or more of a variety of sources or detectors, as will be described in more detail hereinafter. In one example, the clinician 152 inputs the response data 158 to the fitting system 130.

The fitting system 130 is configured to use the response data 158 to create a recipient-specific implant configuration or map data 160. The map data 160 may be stored on the fitting system 130 and downloaded to the memory of the sound processing unit 104 (FIG. 1) of the cochlear implant 50. Other types of hearing prostheses and medical or non-medical devices may be fitted to the recipient 154 using the arrangement 150 of FIG. 2.

In the example shown in FIG. 2 and with further reference to FIG. 1, the sound processing unit 104 of the cochlear implant 50 is communicatively coupled to the fitting system 130 to establish a data communication link 162 between the cochlear implant 50 and the fitting system. The fitting system 130 may thereafter be bi-directionally coupled to the cochlear implant 50 via the data communication link 162. Although the cochlear implant 50 and fitting system 130 are illustrated generally as being connected via a cable in FIG. 2, any communication link now known or later developed may be utilized to communicatively couple these components, for example, a radio link or other wired or wireless communication link.

As illustrated in FIG. 2, the communication link 162 can deliver the stimulation signals 156 and the map data 160 to the cochlear implant 50. Further, the communication link 162 can also deliver response data 158 from the cochlear implant 50 to the fitting system 130. This response data 158 from the cochlear implant 50 can be generated by sensors coupled to or incorporated into the cochlear implant, such as accelerometers, gyroscopes, compasses, and the like for detecting movements of the recipient 154. More particularly, movements of the recipient 154 can be detected and interpreted to determine that the recipient perceived a stimulation signal 156 as sound.

The fitting arrangement 150 also is illustrated with one or more detectors 164 that are communicatively coupled to the fitting system 130 via a data communication link 166. The communication link 166 can be any known or later developed wired or wireless communication link. Generally, the detector(s) 164 are used to monitor the recipient 162 to provide response data 158 to the fitting system 130 through the communication link 166. Thus, in one non-limiting example, the detector(s) 160 may include another person, such as a second clinician 152 or a parent of the recipient 154, who observes the recipient's behavior and generates the response data 158 if they believe that the recipient has perceived a stimulation signal 156 as sound. The detector(s) 164 may also include one or more sensors, such as inertial sensors for detecting movements of the recipient, sensors for tracking eye movement of the recipient, sensors for monitoring the recipient's breathing, neural response telemetry (NRT) sensors for measuring neural responses to stimulus through the electrodes 120 of the cochlear implant 50. Any of these sensors can be used to monitor the recipient 154 and provide data relating to whether the recipient has perceived a stimulation signal 156 as sound.

As discussed generally above, the fitting system 130 can utilize any of the response data 158 to develop map data 156 for the recipient 154. The particular details of the implemented fitting process may be specific to the recipient, to the cochlear implant manufacturer, to the cochlear implant device, etc. As a result, only illustrative example mapping data are described herein.

Typically, cochlear implants utilize two values to be set for each stimulation channel of the array 118 of electrodes 120 of the cochlear implant 50. A stimulation channel may generally include at least one active electrode and at least one reference electrode of the array 118 of electrodes 120. The typical values set for each stimulation channel are referred to as the threshold level (commonly referred to as the “THR” or “T-level”) and the Maximum Comfortable Loudness level (commonly referred to as the Most Comfortable Loudness level, “C-level,” or simply the comfort level). Threshold levels and comfort levels may vary from recipient to recipient and from stimulation channel to stimulation channel. The threshold levels and the comfort levels determine in part how well the recipient hears and understands detected speech and/or sound across a range of frequencies. Other hearing prostheses may have similar maximum and minimum signal intensity levels, such as maximum and minimum acoustic levels or maximum and minimum mechanical vibration levels.

The threshold level corresponds to the level where the recipient first identifies sound sensation. In general, the threshold level is the lowest intensity level of stimulation current that evokes the sensation of sound for a given stimulation channel. In a typical fitting scenario, the threshold level may often be determined for each stimulation channel by passing the recipient's hearing threshold twice using an ascending method and determining the level at which the recipient experiences sound by observing their response, such as indicating gestures in the case of adults or observing behavioral reactions in the case of children.

The comfort level can be used to set the maximum allowable stimulation level for each stimulation channel. Generally, the comfort level corresponds to the maximum intensity level of stimulation current that feels comfortable to the recipient. In setting and establishing the comfort levels for each stimulation channel, it may be typical for an audiologist or clinician to instruct the recipient to indicate a level that is “as loud as would be comfortable for long periods” while slowly increasing the stimulation level for a particular stimulation channel. Alternatively or in conjunction, the audiologist or clinician can observe behavioral reactions of the recipient to estimate the comfort levels for each stimulation channel.

Although the terminology and abbreviations may be device-specific, the general purpose of setting threshold and comfort levels for each channel is to determine a recipient's dynamic range for each channel by defining the lowest intensity levels (threshold levels) and the highest acceptable intensity levels (comfort levels) for each channel.

FIG. 3 shows a block diagram of an example computing device 180 that can be configured as the fitting system 130 of FIGS. 1 and 2. In the present example, the computing device 180 includes a user interface module 182, a communications interface module 184, one or more processors 186, and data storage 188, all of which are shown linked together via a system bus or other connection mechanism 190.

The user interface module 182 is configured to send data to and/or receive data from external user input/output devices. For example, the user interface module 182 may be configured to send/receive data to/from user input devices such as a keyboard, a keypad, a touch screen, a computer mouse, a track ball, a joystick, and/or other similar devices, now known or later developed. The user interface module 182 may also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module 182 may also be configured to generate audible output(s), such as a speaker, speaker jack, audio output port, audio output device, earphones, and/or other similar devices, now known or later developed.

In some embodiments, the user interface module 182 includes or is communicatively coupled to an LCD or similar type of touch screen. The touch screen can be configured to display a user interface and recipient map data and other information. The touch screen is also configured to receive data and commands from a user, such as response data and commands to define or select stimulation signals.

The communications interface module 184 includes one or more wireless interfaces 192 and/or wired interfaces 194 that are configurable to communicate via a communications connection to a hearing prosthesis or to other computing devices, for example. The wireless interfaces 192 can include one or more wireless transceivers, such as a Bluetooth transceiver, a Wi-Fi transceiver, a WiMAX transceiver, and/or other similar type of wireless transceiver configurable to communicate via a wireless protocol. Similarly, the wired interfaces 194 can include one or more wired transceivers, such as an Ethernet transceiver, a Universal Serial Bus (USB) transceiver, or similar transceiver configurable to communicate via a twisted pair wire, a coaxial cable, a fiber-optic link or a similar physical connection.

The one or more processors 186 may include one or more general purpose processors (e.g., microprocessors manufactured by Intel or Advanced Micro Devices) and/or one or more special purpose processors (e.g., digital signal processors, application specific integrated circuits, etc.). The one or more processors 186 are configured to execute computer-readable program instructions 196 that are contained in the data storage 188 and/or other instructions based on algorithms described herein.

In the present example, the data storage 188 includes one or more computer-readable storage media that can be read or accessed by at least one of the processors 186. The one or more computer-readable storage media may include volatile and/or non-volatile storage components, such as optical, magnetic, organic or other memory or disc storage, which can be integrated in whole or in part with at least one of the processors 186. In some embodiments, the data storage 188 is implemented using a single physical device (e.g., one optical, magnetic, organic or other memory or disc storage unit), while in other embodiments, the data storage 188 is implemented using two or more physical devices.

Generally, the data storage 188 includes the computer-readable program instructions 196 and perhaps additional data. In some embodiments, the data storage 188 additionally includes storage required to perform at least part of the herein-described methods and algorithms and/or at least part of the functionality of the systems described herein.

Referring now to FIG. 4 and with further reference to the above description, one example method 200 is illustrated for developing map data for a hearing prosthesis recipient by applying stimulation signals to a hearing prosthesis fitted to the recipient and updating probability data relating to whether the recipient perceived the stimulation signals as sound. The method 200 of FIG. 4 can be implemented by the fitting arrangement 150 of FIG. 2, for example.

In FIG. 4, at a block 202, the fitting system 130 applies a stimulation signal 156 to the cochlear implant 50 fitted to the recipient 154. In one example, the clinician 152 can set the parameters of the stimulation signal 156, e.g., a stimulation channel and a stimulation level. In another example, the fitting system 130 can automate some or the entire stimulation signal setting process, as will be described in more detail hereinafter. In the present method 200, the stimulation signal 156 is associated with initial or a priori probabilities that the recipient 154 will perceive the stimulation signal as an audible sound.

At a block 204, the fitting system 130 receives response data related to whether the recipient 154 perceived the stimulation signal as an audible sound. This response data can be received from one or more sources, for example, the clinician 152 may observe the recipient's behavior and interpret this behavior as a reaction to perceiving the stimulation as sound. In this example, the clinician 152 then provides an input to the fitting system 130 indicating that the clinician thought that the recipient perceived sound. The clinician 152 can provide the input to the fitting system 130 through the user interface module 182 of FIG. 3, for example. In other examples, additional and/or different sources or detectors can provide the response data. For instance, other sources or detectors may include a second individual that is observing the recipient, inertial sensors for detecting head movements of the recipient, sensors for tracking eye movement of the recipient, sensors for monitoring the recipient's breathing, NRT sensors, and the like.

In FIG. 4, at a block 206 the fitting system 130 utilizes the received response data to update the initial or a priori probability that the recipient 154 perceived the stimulation signal as sound, as will be described in more detail hereinafter. Generally, the fitting system 130 and the clinician 152 use the updated probabilities to more reliably establish whether the recipient 154 perceived the stimulation signal 156 as sound or not. The fitting system 130 can also use the updated probabilities for a specific stimulation signal, e.g., a stimulation signal on a particular channel and at a particular level, to update initial probabilities that a recipient 154 will perceive stimulation signals on different channels and/or levels. For instance, given that an initial probability of a 100 CL stimulation signal on channel 11 is 1% and, through the probability updating of block 206, it is determined that on channel 10 a 100 CL stimulation signal is perceived as sound with a probability of 97%, the fitting system 130 can increase the initial probability of the 100 CL stimulation signal on channel 11 from 1% to a greater value. Using this same concept, the fitting system 130 can update the probabilities for other adjacent or non-adjacent channels.

At the block 206, the fitting system 130 can also use the updated probabilities to develop the recipient's map data. For example, given the updated probabilities relating to whether the recipient perceived a given stimulation signal, the fitting system can use statistical estimates to establish the T-levels, C-levels, and other parameters of the recipient's map data.

At a block 208, the fitting system 130 displays the updated probabilities and map data to the clinician as a graph or table. At a block 210, the clinician 152 and/or the fitting system 130 use the updated probabilities to determine a next stimulation signal to apply through the cochlear implant 50. Generally, the clinician 152 and/or the fitting system 130 use the updated probabilities to determine whether the stimulation signal applied at the block 202 provides a sufficient level of certainty regarding whether the recipient 154 perceived the stimulation signal as sound or not.

For example, the fitting system 130 may compare the updated probability to an upper probability threshold to determine whether there is a sufficient level of certainty regarding whether the recipient perceived the stimulation signal and/or may compare the updated probability to a lower probability threshold to determine whether there is a sufficient level of certainty regarding whether the recipient did not perceive the stimulation signal as sound. Illustratively, the upper probability threshold can be set to 80% or higher, such that, if the fitting system 130 determines that the updated probability was greater than the upper probability threshold, the fitting system can select a new channel and/or level for a next stimulation signal. Similarly, the lower probability threshold can be set to 20% or lower, such that if the fitting system 130 determines that the updated probability was less than the lower probability threshold, the fitting system can select a new channel and/or level for a next stimulation signal.

This decision to select a new channel and/or level can be based on statistical analyses to determine which new channel and/or level would potentially provide the most relevant information. For example, if it is determined that at channel 10 the T-level is about 180 CL, then there is a low probability that testing channel 11 with a stimulation signal at 100 CL will provide much relevant information. Using these concepts, the next stimulation signal can be determined and applied by the fitting system 130 during the block 202. More particularly, in one embodiment of the present disclosure, the fitting process can be automated by the fitting system 130, which can select stimulation signals, apply the signals, and update probabilities and map data, all with minimal input from the clinician 152.

Referring again to the processes of the block 206, the fitting system 130 can update the initial or a priori probabilities using a Bayesian updating algorithm or a maximum likelihood estimation algorithm. More particularly, the Bayesian updating algorithm, utilizes the following Equation 1:

$$P ( H \vert E ) = \frac{P ( E \vert H ) P ( H )}{P ( E \vert H ) P ( H ) + P ( E \vert \overline{H} ) P ( \overline{H} )} \qquad ( 1 )$$

In Equation 1, H represents a hypothesis. In the context of the present disclosure, H represents the hypothesis that a stimulation signal at a specific CL is audible to the hearing prosthesis recipient. Further, in Equation 1, the initial or a priori probability is represented by P(H), which in the present context is the probability that a stimulation signal is audible to the recipient. Further, in Equation 1, E represents an event. In the present disclosure the event E is related to the response data and whether a detector (e.g., sensor, clinician, or other individual) determines that the recipient has perceived a stimulation signal as sound. A conditional probability P(E|H) (also referred to as selectivity) represents the probability that the detector will correctly determine that the recipient perceived the stimulation signal as sound given that the recipient actually did perceive the signal as sound.

Still further, H̅represents “not H” or the hypothesis that the stimulation signal is not audible to the recipient. Accordingly, P( H̅) represents the a priori probability that the stimulation signal is not audible to the recipient. In the present example, P( H̅)=1−P(H). Similarly to the conditional probability P(E|H), Equation 1 also includes a conditional probability P(E| H̅) that represents the probability that the detector will determine that the recipient did perceive the stimulation signal as sound given that the recipient actually did not perceive the signal as sound. The conditional probability P(E| H̅) is also related to a specificity of the fitting process. For purposes of the present discussion, it is sufficient to equate the conditional probability P(E| H̅) to (1—“specificity”).

In Equation 1, P(H|E) represents the updated or a postiori probability that the recipient perceived the stimulation signal as sound given that the fitting system received response data indicating that the recipient perceived sound. When the probability P(E|H) is high (perhaps greater than about 90%), there is greater certainty that the recipient did perceive the stimulation signal as sound, and when the probability P (H|E) is low (perhaps less than about 20%) there is greater certainty that the recipient did not perceive the stimulation signal as sound. Accordingly, as discussed generally above, the probability P (H|E) can be updated and made more accurate by applying additional stimulation signals and receiving response data, which, in turn, is used to develop the map data for the recipient.

In one non-limiting example of the Equation (1) in use by the fitting system 130, a stimulation signal is applied on a given channel at a level of 100 CL. The probability P(H) that such a stimulation signal is audible to a recipient in the vast majority of cases can be estimated through historical data analysis. In the present example, P(H)=0.01, or, in other words, such a stimulation signal would be inaudible to about 99 out of 100 recipients. Nevertheless, the stimulation signal at 100 CL is applied to the recipient and the detector (e.g., sensor, clinician, or other individual) observes a behavioral response in the recipient that causes the detector to provide response data indicative of a determination that the recipient perceived the 100 CL stimulation signal as sound. In the present example, the detector has an estimated specificity of 0.8 and a selectivity of 0.6. In other words, the detector correctly identifies 60% of responses in the recipient and correctly does not identify a response in 80% of the stimulation signals that are non-audible to the recipient. Following Equation 1 the updated probability that the recipient perceived the stimulation signal as sound is:

$$P ( H \vert E ) = \frac{0.01 * 0.6}{0.01 * 0.6 + 0.99 * ( 1 - 0.8 )} = 0.029$$

Thus, it is still very unlikely that the 100 CL stimulation signal was indeed audible to the recipient. However, since the fitting system 130 received response data from a detector indicting that the recipient appeared to perceive the stimulation signal as sound, the fitting system 130 can re-apply the stimulation signal to check again whether the recipient appears to perceive the stimulation signal. If there is again a perceived response, the updated probability P(H|E) calculated using Equation (1) rises to 0.0832. This calculation is performed by replacing the a priori probability P(H) of 0.01 with the updated probability P(H|E) of 0.029.

Yet another application of the same stimulation signal and a perceived response would increase P(H|E) to 0.22, and subsequently to 0.46, 0.72, 0.88, 0.96, etc. Consequently, even though the initial or a priori probability of the recipient hearing the 100 CL stimulation signal was quite low, if the fitting system 130 receives enough response data indicating that the recipient did perceive the stimulation signal, at some point the updated probability P (H|E) rises to a high enough level where the fitting system can determine with a high degree of certainty that the recipient did (or did not) perceive the stimulation signal.

In another illustrative example, a stimulation signal is applied on a given channel at a level of 170 CL. In this case, 170 CL is about the median T-Level, such that P(H)=0.5. Using the same values for the specificity and the selectivity as above, if a single stimulation signal at 170 CL is applied and the fitting system receives response data indicating that the recipient perceived the sound, then the updated probability P(H|E) becomes 0.57, although if no response data is received, the updated probability P(H|E) drops to 0.43.

Referring again to the blocks 204-206 of FIG. 4, as discussed generally above, multiple detectors can input response data to the fitting system, which can use the response data to further update the probability that a recipient perceived a stimulation signal as sound. In one example, a first detector is a clinician associated with a specificity of 0.8 and a selectivity of 0.6, as described in the above example. Further, in the present example, a second detector that is second clinician or perhaps the recipient's parent can also provide response data to the fitting system. Here, the second detector is associated with a specificity of 0.8 and a selectivity of 0.5. In other words, the second detector is less accurate than the first detector and misses about half of the recipient's responses to stimulation signals that the recipient perceives as sound. The fitting system can calculate updated probabilities P (HIE) using Equation 1 and the response data from each of the detectors to more quickly determine whether the recipient perceived the stimulation signal as sound or not. More particularly, the fitting system calculates an updated probability P(H|E) using Equation 1 based on response data from the first detector and uses this updated probability P(H|E) as the P(H) in Equation 1 based on response data from the second detector. The following Table 1 illustrates how the use of the two detectors in the present example can allow the fitting system to more quickly determine a recipient's response to a stimulation signal at 100 CL.

TABLE 1
Updated probabilities with 1 and 2 detectors

| Update No | 1 detector | 2 detectors |
|---|---|---|
| 0 | 0.01 | 0.01 |
| 1 | 0.03 | 0.07 |
| 3 | 0.08 | 0.35 |
| 4 | 0.22 | 0.80 |
| 5 | 0.46 | 0.97 |
| 6 | 0.72 | 1.00 |
| 7 | 0.88 | 1.00 |
| 8 | 0.96 | 1.00 |

Table 1 illustrates that even when adding another relatively poor detector (with a fairly low selectivity of 0.5), the fitting system can determine with a high degree of certainty that the recipient perceived the stimulation signal as sound after only about five trials, as opposed to the eight trials that it would take to reach the same degree of certainty with only the first detector. Table 1 assumes that the two detectors agree and provide response data in each of the trials, which of course in practice will often not be the case. However, in any event, it can be seen from this example that including additional detectors can allow the fitting system to improve its accuracy while applying fewer stimulation signals.

Further, as discussed generally herein, the detectors are not limited to individuals but may include any number of sensors that monitor the behavior of the recipient. Such sensors and/or the fitting system can be configured to interpret the behavior of the recipient as response data indicating that the recipient perceived a stimulation signal as sound. Thereafter, such response data can be used to update probabilities as described herein.

As mentioned above, at the block 206, the fitting system 130 can also use a maximum likelihood estimation (MLE) algorithm to update probabilities that a recipient perceived a stimulation signal. In an illustrative fitting session, a plurality of stimulation signals at one or more stimulation levels are applied to the cochlear implant or other hearing prosthesis fitted to the recipient, such as at the block 202 of FIG. 4. At the block 204, response data is recorded for each stimulation signal. The data from the fitting session can be described by a dataset characterized by Equation 2:

T=(T₁,T₂, . . . ,Tₘ)

R^{y}=(R₁^{y},R₂^{y}, . . . ,Rₘ^{y})

Rⁿ=R₁ⁿ,R₂ⁿ, . . . ,Rₘⁿ) (2)

In the above dataset, T represents an array containing the applied stimulation signals and R corresponds to perceived recipient responses to the stimulation signals. More particularly, Rᵢ^{y} represents the number of instances where a response is received indicating that the recipient perceived a stimulation signal Tᵢ and Rᵢⁿ represents instances where no response is received for the stimulation signal Tᵢ. For purposes of the following discussion, it is assumed that the array T is ordered from low to high and all the values are unique in accordance with Equation 3:

Tᵢ₊₁>Tᵢ (3)

In the present MLE example, a probability that the recipient will perceive a stimulation signal is a binary probability. More particularly, if the stimulation signal is below an actual threshold level Θ, the probability relates to a false positive rate p^{FP} and, if the stimulation signal is above the threshold level Θ, the probability relates to a true positive rate p^{TP}. The false positive rate p^{FP} and the true positive rate p^{TP} are total combined rates representing the probability that the stimulation signal will be perceived by the recipient and the probability that the recipient's perception of the stimulation signal will be recognized by an observer, such as a clinician. This binary analysis of the probability is used for illustrative purposes, however, in practice the probabilities are more complex. For example, a recipient will respond more often to stimuli that are well above the threshold than to stimuli that are closer to threshold. Also, if a recipient response to a stimulus is stronger or more noticeable, the false negative rate of the observer can be adjusted lower. Generally, the relationship between the stimulus intensity and the probability that the recipient perceived the stimulus can be modelled as a psychometric curve. Such a psychometric curve typically has an integrated Gaussian or sigmoid shape.

That said, using the current model, it is possible to calculate for all possible values of the threshold Θ what the likelihood is that the dataset of Equation 2 would be produced. Assuming that p^{FP} and p^{TP} are known, (T₁, T₂, . . . , Tⱼ) represents all the stimulation signals delivered under a certain assumed value for the threshold Θ (Tⱼ<Θ), and (Tⱼ₊₁, Tⱼ₊₂, . . . , Tₘ) represents all the stimulation signals delivered above the assumed threshold Θ. For every value of j we can calculate the likelihood that the dataset from Equation 2 would have been reproduced.

More specifically, if we assume the conditions in Equation 3, the probability density function of the data set of Equation 2 is a binomial distribution for every Tⁱ and the likelihood L that the dataset would have been produced by a particular threshold Θ can be written as Equation 4:

$$L ( Θ \vert T , {R}^{y} , {R}^{n} , {P}^{FP} , {P}^{TP} ) = {A}_{Θ} * {\prod }_{i = 1}^{j} ( {( {p}^{FP} )}^{{R}_{i}^{y}} * {( 1 - {p}^{FP} )}^{{R}_{i}^{n}} * \frac{( {R}_{i}^{y} + {R}_{i}^{n} ) !}{{R}_{i}^{y} ! * {R}_{i}^{n} !} ) * … {\prod }_{i = j + 1}^{m} ( {( {p}^{TP} )}^{{R}_{i}^{y}} * {( 1 - {p}^{TP} )}^{{R}_{i}^{n}} * \frac{( {R}_{i}^{y} + {R}_{i}^{n} ) !}{{R}_{i}^{y} ! * {R}_{i}^{n} !} ) \qquad ( 4 )$$

In Equation 4, A_{Θ} is the a priori probability that Θ is the threshold, and Tᵢ<Θ for every i<j, and Tᵢ>Θ for every i>j. Generally, since all the statistical events are independent, Equation 4 multiplies together the results at different stimulation levels. More particularly, Equation 4 includes two multipliers (π(expression)), one for all the responses below the assumed current level j, and one for all the responses above the assumed current level j. The expression inside the multipliers is a binomial probability density (PDF) formula for x hits out of n trials with a probability of p, as represented in Equation 5:

$${PDF}_{Binomial} ( n , x , p ) = \frac{n !}{( n - x ) ! x !} * {p}^{x} * {( 1 - p )}^{( n - x )} \qquad ( 5 )$$

The result of multiplying the multiplier expressions is further multiplied with the a priori likelihood A_{Θ}, which can be generally estimated from hearing prosthesis recipient population statistics. In the present example, the fitting system 130 can perform these calculations for all possible values of the threshold Θ, and the result is an array L=(L₁, L₂, . . . , Lₘ₋₁) where every Lᵢ represents the likelihood that the dataset would have been produced if the threshold Θ was between Tᵢ and Tᵢ₊₁. Next, the maximum value of the array L can be identified to provide an estimate for the threshold Θ.

In one non-limiting example, the false positive rate p^{FP}=0.2, the true positive rate p^{TP}=0.9, and the a priori likelihoods A_{Θ} for various thresholds Θ are provided in the following Table 2.

TABLE 2
a priori likelihoods A_{Θ} for thresholds Θ

| Θ | A_{Θ} |
|---|---|
| 130 | 0 |
| 140 | 0.20 |
| 150 | 0.40 |
| 160 | 0.20 |
| 170 | 0.20 |
| 180 | 0 |

From Table 2, a priori, the most likely threshold is around 150 CL.

In the present example, a stimulation signal T is then applied at 155 CL and no response is detected. Thus, Tᵢ=(155), Rᵢ^{y}=(0), and Rᵢⁿ=(1). With these values, the likelihoods L can be calculated using Equation 4 to arrive at the values listed in Table 3.

TABLE 3
Likelihoods L_{Θ} for thresholds Θ

| Θ | L_{Θ} |
|---|---|
| 130 | 0 |
| 140 | 0.02 |
| 150 | 0.04 |
| 160 | 0.16 |
| 170 | 0.16 |
| 180 | 0 |

From Table 3, after applying the stimulation signal T at 155 CL, now the most likely threshold value is at or around 160 CL or 170 CL, instead of at around 150 CL.

Next, another stimulation signal T is applied at 165 CL and this time a response is detected. Thus, Tᵢ=(155, 165), Rᵢ^{y}=(0, 1), and Rᵢ^{y}=(1, 0). With these new values, the likelihoods L can again be calculated using Equation 4 to arrive at the values listed in Table 4.

TABLE 4
Likelihoods L_{Θ} for thresholds Θ

| Θ | L_{Θ} |
|---|---|
| 130 | 0 |
| 140 | 0.018 |
| 150 | 0.036 |
| 160 | 0.144 |
| 170 | 0.032 |
| 180 | 0 |

From Table 4, now the most likely threshold value is at around 160 CL, which makes intuitive sense since no response was detected at 155 CL and a response was detected at 165 CL.

Performing this process again, another stimulation signal T is applied at 165 CL and this time no response is detected. Thus, Tᵢ=(155, 165), Rᵢ^{y}=(0, 1), and Rᵢ^{y}=(1, 1). With these new values, the likelihoods L can again be calculated using Equation 4 to arrive at the values listed in Table 5.

TABLE 5
Likelihoods L_{Θ} for thresholds Θ

| Θ | L_{Θ} |
|---|---|
| 130 | 0 |
| 140 | 0.0036 |
| 150 | 0.0072 |
| 160 | 0.0288 |
| 170 | 0.0912 |
| 180 | 0 |

From Table 5, now the most likely threshold value is at around 170 CL. Thereafter, the process of applying stimulation signals T, which can be the same signals or different signals, is repeated and the likelihoods L for different thresholds Θ are calculated until a sufficiently high level of certainty is obtained for the threshold value.

Further, confidence C of the estimated threshold Θ can be determined by comparing the maximum Lᵢ value of the array L with the next largest Lᵢ value. More particularly, the larger the difference between the maximum Lᵢ and the next largest Lᵢ, the greater the confidence C there is in the estimate of the threshold Θ. If we normalize the array L, then the ideal confidence C is achieved if the maximum Lᵢ value is one and all other values of Lᵢ are zero, which will only occur if p^{FP} and p^{TP} are zero and one, respectively, or only after an infinite number or relatively large number of repeat measurements. In practice, the closer the maximum Lᵢ value is to one the more confidence C there is in the estimate of the threshold Θ.

Referring again to the block 210 of FIG. 4, the MLE algorithm can also be used to select a new channel and/or level for the next stimulation signal. For example, using the data set (T, R^{y}, Rⁿ) of Equation 2, the fitting system 130 can calculate a probability, for every possible stimulus Tᵢ, of receiving a yes or no response for a particular stimulation signal. This probability can be calculated using the likelihood estimation of Equation 4 combined with the (known) false positive and false negative rates.

After calculating the probability, the fitting system 130 can recalculate the likelihoods and the confidence C for every possible stimulus Tᵢ and weigh the updated confidence values with the relative likelihoods of every outcome. In this way, the fitting system 130 can create an array Z where every element Zᵢ gives an estimated change in confidence C for each stimulation signal Tᵢ. Thereafter, the fitting system 130 can select the largest value of Zᵢ, which corresponds to a stimulation value that will likely give the most additional information about the threshold Θ.

Another aspect of the fitting system 130 selecting a next stimulation signal includes preventing the selected next stimulation signal from being too high or uncomfortable for the recipient. In one example, selecting an uncomfortable next stimulation signal can be minimized by not taking the largest value of Z but a value of Z above some threshold with the lowest Tᵢ.

Referring now to FIG. 5, an example method 220 is illustrated, which can be implemented within the context of the method 200 of FIG. 4. At a block 222 of the method 220, the clinician 152 defines a stimulation signal time frame, within which the fitting system 130 may or may not apply a stimulation signal 156 to the cochlear implant 50 fitted to the recipient 154. The clinician 152 may set the parameters of the stimulation signal 156, e.g., a stimulation channel and a stimulation level. Alternatively, the fitting system 130 can set the parameters of the stimulation signal 156. Generally, the clinician 152 instructs the fitting system 130 to start a stimulation signal time frame when the recipient 154 is attentive. In another variation of the method of FIG. 5, the fitting system 130 can arbitrarily define the stimulation signal time frame or can use inputs from one or more sensors to estimate an attentive state of the recipient 162 and inform the clinician 152 when a stimulation signal time frame is initiated, all with minimal input from the clinician.

Thereafter, at a block 224, the fitting system 130 decides whether or not to apply the stimulation signal. The clinician and other detectors may not be made aware of the decision to apply the stimulation signal or not. In this manner, any subjective bias of the clinician and other detectors can be minimized.

The fitting system 130 receives response data from any number of detectors at a block 226. At a block 228, the fitting system 130 tracks received response data when no stimulation signal was applied (an “empty” frame) to gather false positive response data. The fitting system 130 can use this false positive response data to update or refine specificity values associated with one or more detectors. At the block 228, the fitting system 130 can also track received response data when a stimulation signal was applied but no response data was received to gather false negative response data. The fitting system 130 can use this false negative response data to update or refine selectivity values associated with one or more detectors. The process of updating selectivity values may utilize multiple detectors so that response data from the detectors can be compared to each other or may utilize an adult recipient, who can later confirm whether or not they perceived a stimulation signal as sound.

Referring again to the MLE algorithm discussed above, the false positive rate p′ can be estimated by using response data when no stimulation signal was applied, as described above. Generally, in the context of the MLE algorithm, a reasonable number of trials (applied stimulation signals) are required to get a good estimate for the false positive rate p^{FP}. To accumulate data for improving estimates of the false positive rate p^{FP}, the methods and systems disclosed herein can track p^{FP} across different hearing prosthesis electrodes or can track p^{FP} for specific combinations of hearing prosthesis recipients and detectors (e.g., particular clinicians or audiologists).

One process that can be used to update the false positive rate p^{FP} at the block 228 is to use an a priori estimate of p^{FP}, which can be, for example, a mean false positive rate for a general population of relevant detectors or the mean false positive rate for a particular detector). The a priori p^{FP} estimate can then be replaced by a false positive rate measured using the processes of FIG. 5 or some other process when an updated value of p^{FP} is determined with sufficient confidence.

In one example, the a priori estimate of p^{FP} can be established using a binomial proportion confidence interval, such as the Agresti-Coull method. In the Agresti-Coull method, the PDF(n,x,p) formula of Equation 5 can be used to estimate the probability density function of the binomial probability that a recipient will perceive a stimulation signal, as described generally above. In addition, the present example can be used to estimate the confidence interval of the distribution parameters. In this case, n is the number of empty stimulation frames, x is the number of false positive responses detected, and p is the false positive rate p^{FP}. In the Agresti-Coull method, if a confidence of z percentile of the standard normal distribution is desired (for example, if a 95% confidence is desired, z=1.96) then an unbiased estimator for p can be established by Equation 6:

$$\tilde{p} = \frac{x + {z}^{2} / 2}{n + {z}^{2}} \qquad ( 6 )$$

In the example above where z=1.96, the result of Equation 6 is roughly equivalent to the known rule of thumb “add 2 failures and 2 successes.” Consequently, the confidence interval is characterized by Equation 7:

$$\tilde{p} \pm z \sqrt{\frac{\tilde{p} ( 1 - \tilde{p} )}{n + {z}^{2}}} \qquad ( 7 )$$

Generally, smaller confidence intervals or ranges correspond to greater certainty that the estimated rate is accurate. Further, increasing the number of data points or trials generally helps to decrease the confidence interval and, thereby, increases certainty in the estimate.

Utilizing the Agresti-Coull method and Equations 6 and 7 above, one method for establishing the false positive rate p^{FP} includes applying empty frames, receiving response data, and updating the estimated false positive rate in Equation 6. When the a priori value for p^{FP} falls outside the confidence interval of Equation 7, the a priori p^{FP} is replaced by the \ddot{p}calculated by Equation 6.

Referring now to the true positive rate p^{TP}, one process for estimating this rate is by assuming an average value based on population statistics. Another process for estimating the true positive rate p^{TP} can include using the Agresti-Coull estimator and Equations 6 and 7 where n is the number of stimulation frames, x is the number of positive responses received, and for a 95% confidence, z=1.96.

In one example, for a sample data set of Equation 2, we have Tᵢ=(150, 160, 170, 180, 190), Rᵢⁿ=(3, 4, 0, 0, 1), and Rᵢ^{y}=(0, 0, 2, 2, 1). In this example, the most likely threshold value is 165, which for purposes of this example is assumed to be the actual threshold. Thus, from the data set above, it is determined that there were seven (7) trials (3+4+0+0) below this threshold. Further, it is determined that there were six (6) trials (2+2+1+0+0+1) above the threshold with five (5) of the trials giving a positive response. Based on this, an estimate for the true positive rate p^{TP} using the rule of thumb “add 2 failures and 2 successes” adds two (2) positive responses for a total of seven (7) and adds two (2) negative responses for a total of three (3), which further results in a total of ten (10) total responses. Using this rule of thumb, the estimated true positive rate p^{TP}=0.7 (7/10).

This estimated true positive rate is roughly equivalent to the true positive rate calculated using Equation 6, with x=5, n=6, and z=1.96, i.e., p^{TP}=0.703. However, using these same values in Equation 7, the confidence interval equals 0.703±0.29, which provides a fairly inaccurate range for the true positive rate of between about 0.41 and 0.99. As discussed generally above, increasing the number of trials and responses will generally improve this confidence interval.

As mentioned above, the method 220 can be implemented within the context of the method 200 of FIG. 4, such that the blocks 222-228 of FIG. 5 can be implemented in parallel with or instead of one or more of the blocks 202-210 of FIG. 4. For example, the block 202 of FIG. 4 can be replaced by the blocks 222-224 of FIG. 5 and the blocks 226-228 can be implemented before, during, or after the blocks 204-206 of FIG. 4.

Although the blocks 202-210 of FIG. 4 and the blocks 222-228 of FIG. 5 are illustrated in a sequential order, the blocks may also be performed in parallel, and/or in a different order than described herein. The methods 200, 220 may also include additional or fewer blocks, as needed or desired. For example, the various blocks 202-210, 222-228 can be combined into fewer blocks, divided into additional blocks, and/or removed based upon a desired implementation.

In addition, each block 202-210, 222-228 may represent a module, a segment, or a portion of program code, which includes one or more instructions executable by a processor for implementing specific logical functions or steps in the process. The program code may be stored on any type of computer readable medium or storage device including a disk or hard drive, for example. The computer readable medium may include non-transitory computer readable medium, such as computer-readable media that stores data for short periods of time like register memory, processor cache, and Random Access Memory (RAM). The computer readable medium may also include non-transitory media, such as secondary or persistent long term storage, like read only memory (ROM), optical or magnetic disks, compact-disc read only memory (CD-ROM), etc. The computer readable media may also include any other volatile or non-volatile storage systems. The computer readable medium may be considered a computer readable storage medium, for example, or a tangible storage device. In addition, one or more of the blocks 202-210, 222-228 may represent circuitry that is wired to perform the specific logical functions of the methods 200, 220.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A hearing prosthesis fitting system comprising:
a first interface configured for applying a stimulation signal to a recipient of the hearing prosthesis, wherein the stimulation signal is associated with a prior probability that the recipient will perceive the stimulation signal as an audible sound;
a second interface configured for receiving response data relating to whether the recipient perceived the stimulation signal as an audible sound; and
a processor configured to determine an updated probability that the recipient perceived the stimulation signal as an audible sound, wherein the processor is configured to utilize the received response data and the prior probability to determine the updated probability.

2. The hearing prosthesis fitting system of claim 1, wherein the second interface is configured to receive response data from a plurality of different detectors that monitor behavior of the recipient.

3. The hearing prosthesis fitting system of claim 1, wherein the processor is configured to utilize the determined first-named updated probability to determine a second updated probability that the recipient will perceive a second stimulation signal different than the first-named stimulation signal.

4. The hearing prosthesis fitting system of claim 1, wherein the processor is configured to control a display device to display the updated probability.

5. The hearing prosthesis fitting system of claim 1, wherein the processor is configured to utilize the updated probability to select a second stimulation signal to apply to the recipient.

6. The hearing prosthesis fitting system of claim 1, wherein the processor is configured to utilize a Bayesian updating algorithm to determine the updated probability.

7. The hearing prosthesis fitting system of claim 1, wherein the processor is configured to utilize a maximum likelihood estimation algorithm to determine the updated probability.

8. The hearing prosthesis fitting system of claim 1, wherein the processor is configured to compare the updated probability to an upper probability threshold and a lower probability threshold to determine whether to apply a second stimulation signal different than the first-named stimulation signal.

9. A method of utilizing a fitting system to fit a hearing prosthesis for a recipient, comprising:
generating a stimulation signal for a recipient of a hearing prosthesis, wherein the stimulation signal is associated with a first probability that the recipient will perceive the stimulation signal;
receiving first response indicia from a first detector, the first response indicia relating to whether the recipient perceived the stimulation signal;
receiving second response indicia from a second detector, the second response indicia relating to whether the recipient perceived the stimulation signal;
determining a second probability that the recipient perceived the stimulation signal, wherein determining the second probability includes the fitting system utilizing the first response indicia, the second response indicia, and the first probability.

10. The method of claim 9, further comprising determining a third probability that a recipient will perceive a different stimulation signal, wherein determining the third probability includes the fitting system utilizing the second probability.

11. The method of claim 9, further comprising selecting a second stimulation signal for the recipient, wherein selecting the second stimulation signal includes the fitting system utilizing the second probability.

12. The method of claim 9, wherein one or more of the first and second detectors is unaware of the generating of the stimulation signal.

13. The method of claim 9, further comprising:
defining a stimulation signal time frame, during which the fitting system determines whether or not to generate the stimulation signal;
receiving at least one of third and fourth response indicia from the first and second detectors, respectively, wherein at least one of the first and second detectors are unaware of whether the fitting system generated the stimulation signal during the stimulation signal time frame; and
updating at least one of specificity and selectivity values associated with at least one of the first and second detectors, wherein updating at least one of the specificity and selectivity values includes the fitting system utilizing one or more of the third and fourth response indicia.

14. The method of claim 9, wherein determining the second probability includes utilizing a Bayesian updating algorithm.

15. The method of claim 9, wherein determining the second probability includes utilizing a maximum likelihood estimation algorithm.

16. An article of manufacture including a non-transitory computer-readable medium with instructions stored thereon, the instructions comprising:
instructions for generating a first stimulation signal for a recipient of a medical prosthesis, wherein the first stimulation signal is associated with a first likelihood that the recipient will perceive the first stimulation signal;
instructions for receiving response data relating to whether the recipient perceived the first stimulation signal;
instructions for determining a second likelihood that the recipient perceived the first stimulation signal, wherein determining the second probability utilizes the response data and the first likelihood;
instructions for generating a second stimulation signal for the recipient, wherein generating the second stimulation signal utilizes the second likelihood.

17. The article of manufacture of claim 16, further comprising instructions for receiving second response data from a different source than the first-named response data, and wherein the instructions for determining the second likelihood include instructions to utilize the first-named response data, the second response data, and the first likelihood.

18. The article of manufacture of claim 16, further comprising instructions for utilizing the second likelihood to determine a third likelihood that the recipient will perceive a third stimulation signal different than the first stimulation signal.

19. The article of manufacture of claim 16, further comprising instructions for utilizing a Bayesian updating algorithm to determine the second likelihood.

20. The article of manufacture of claim 16, further comprising instructions for utilizing a maximum likelihood estimation algorithm to determine the second likelihood.

21. The article of manufacture of claim 16, further comprising instructions for displaying the second likelihood.
